(19) United States
(12) Patent Application Publication
(10) Pub. No.: US 2026/0258934 A1
(43) Pub. Date: Sep. 3, 2026

(54) SPLICING ROD OF OUTDOOR EQUIPMENT AND STREET LAMP

(71) Applicant: DONGGUAN THAILIGHT SEMICONDUCTOR LIGHTING CO., LTD, Dongguan City (CN)

(72) Inventor: Wenbo ZHOU, Dongguan (CN)

(21) Appl. No.: 18/832,352

(22) PCT Filed: May 20, 2024
(86) PCT No.: PCT/CN2024/094222

§ 371 Date: Jul. 23, 2024

(30) Foreign Application Priority Data
Feb. 6, 2024 (CN) 202420285109.3
Apr. 3, 2024 (CN) 202420692612.0

(51) Int. Cl. F21V 21/116; F21S 9/03; F21V 21/088; F21V 21/26; F21W 131/103

(52) U.S. Cl. CPC F21V 21/116; F21S 9/035; F21V 21/088; F21V 21/26; F21W 2131/103

(57) ABSTRACT

A splicing rod of outdoor equipment includes a base provided at a bottom of the splicing rod of outdoor equipment to support, rod bodies arranged up and down along an axis, a rotating buckle provided between two adjacent rod bodies and a rod cover for installing outdoor equipment; the number of the rod bodies is two or more, the rotating buckle includes an upper buckle fixedly connected to an upper rod body and a lower buckle fixedly connected to a lower rod body, the upper buckle and the lower buckle may be rotated relatively around the axis of the rod bodies, the base is fixedly provided on a bottom of a lowest rod body, the rod cover is provided on a top of a uppermost rod body. In addition, the present application further disclosed a lamp street using the splicing rod of outdoor equipment.

### CROSS-REFERENCE TO RELATED APPLICATION

This application is a national application of PCT/CN2024/094222, filed on May 20, 2024. The contents of PCT/CN2024/094222 are all hereby incorporated by reference.

### FIELD OF TECHNOLOGY

The present application relates to the technical field of installation technologies of outdoor equipment, and in particular to a splicing rod of outdoor equipment and a street lamp.

### BACKGROUND

Prior outdoor equipment such as street lamp, billboard, rod sign, etc. usually needed to erect a rod with a certain length for support, so that it can be seen by people from a distance. However, the rod with a certain length is not only not easy to transport, but also requires a corresponding equipment to raise it overall to erect, which is very troublesome and laborious.

### SUMMARY

Based on this, a purpose of the present application is to provide a splicing rod of outdoor equipment to improve installation efficiency of the outdoor equipment.

This application is implemented through following technical solution:

A splicing rod of outdoor equipment, including:
a base provided at a bottom of the splicing rod of outdoor equipment to support, the base is fixedly provided on a bottom of a lowest rod body;
two or more rod bodies, wherein, each rod body of the rod bodies is arranged up and down along an axis;
a rotating buckle, a rotating buckle, wherein, the rotating buckle is located between two adjacent rod bodies, and includes an upper buckle fixedly connected to an upper rod body and a lower buckle fixedly connected to a lower rod body, and the upper buckle and the lower buckle is able to rotate relative to each other around the axis of the rod bodies;
a rod cover configured to install outdoor equipment, wherein, the rod cover is provided on a top of an uppermost rod body.

Compared with the prior art, the splicing rod of outdoor equipment of the present application achieves an installation and disassembly of two adjacent rod bodies by rotating the upper buckle or the lower buckle, which is easy and convenient, thus improving an efficiency of the installation of the splicing rod of outdoor equipment. Also, dividing the rod into a plurality of rod bodies may reduce requirements of transportation and installation of equipment, thus reducing costs of transportation and installation.

Furthermore, one of the lower buckle and the upper buckle is provided with a clamping slot, the other of the lower buckle and the upper buckle is provided with a clamping block, the clamping block is engaged into or disengaged from the clamping slot as the lower buckle rotates relative to the upper buckle, thus quick installation between the upper buckle and the lower buckle is achieved.

Furthermore, the clamping slot is provided on the lower buckle; the lower buckle is further provided with a lower base, a lower connecting cylinder, a lower connecting block and a stepped hole; the upper buckle is installed on the lower base, a lower flange extending along a periphery of the lower base is protrudingly provided on one side of the lower base away from the upper buckle; the lower connecting cylinder is protrudingly provided on one side of the lower base away from the upper buckle, the upper buckle is inserted into the lower connecting cylinder, and an axis of the upper buckle is parallel to the axis of the rod bodies, the clamping slot is provided on an inner sidewall of the lower connecting cylinder; the lower connecting block surrounds an outside of the lower connecting cylinder and has a gap between the lower flange, the rod body is disposed between the lower flange and the lower connecting block; the stepped hole passes through the lower base, an axis of the stepped hole is parallel to the axis of rod bodies, and a diameter of one side of the stepped hole near to the upper buckle is larger than a diameter of one side of the stepped hole away from the upper buckle. This achieves a stable connection between the rod body and the lower buckle, and is convenient for installation between the upper buckle and the lower buckle.

Furthermore, the rod bodies are hollow inside, at least one end of each rod body of the rod bodies is provided with a positioning block and a mounting hole, the positioning block is protrudingly provided at an inner wall of the rod body, the mounting hole is provided on the positioning block and is communicated with the stepped hole; a lower concave portion concave to an interior of the lower connecting cylinder is provided on an outside sidewall of the lower connecting block; the positioning block is inserted into the lower concave portion to facilitate positioning of the rod body on the lower buckle.

Furthermore, the clamping slot includes a first clamping block and a second clamping block, the first clamping block and the second clamping block are protrudingly provided on the inner sidewall of the lower connecting cylinder and separated from each other with a certain distance; when projects along the axis of the rod bodies, at least one part of the first clamping block and the second clamping block do not overlap to allow the upper buckle to be easily inserted into the clamping slot.

Furthermore, the upper buckle is provided with an upper base, an upper connecting cylinder, an upper connecting block, a clamping block and a mounting hole; one side surface of the upper base is in contact with the lower base, and an upper flange extending along an outer periphery of the upper base is protrudingly provided on one sidewall of the upper base facing away from the lower base; the upper connecting cylinder is protrudingly provided on one side of the upper base facing the lower base, and an axis of the upper connecting cylinder is parallel to the lower connecting cylinder; the upper connecting block surrounds an outside of the upper connecting cylinder, and has a gap with respect to the upper flange; the clamping block is protrudingly provided on an outer sidewall of the upper connecting cylinder; the mounting hole is provided on the upper base and communicated with the stepped hole, an engagement between the upper buckle and the lower buckle is achieved by the engagement of the clamping block and the clamping slot.

Furthermore, an upper concave portion concave to an interior of the upper connecting cylinder is provided on an outer sidewall of the upper connecting block, the positioning block is inserted into the upper concave portion to achieve positioning between the upper buckle and the rod body.

According to another aspect of this disclosure, a street lamp is disclosed,
wherein, the street lamp includes a splicing rod of outdoor equipment and a street lamp assembly, the splicing rod of outdoor equipment includes:
a base provided at a bottom of the splicing rod of outdoor equipment to support;
rod bodies, wherein, the number of rod bodies is two or more, each rod body of the rod bodies is arranged up and down along an axis, and
a plurality of rotating buckles, a rotating buckle, wherein, the rotating buckle is located between two adjacent rod bodies, and includes an upper buckle fixedly connected to an upper rod body and a lower buckle fixedly connected to a lower rod body, and the upper buckle and the lower buckle is able to rotate relative to each other around the axis of the rod bodies, the base is fixedly provided on a bottom of a lowest rod body;
a rod cover configured to install outdoor equipment, wherein, the rod cover is provided on a top of an uppermost rod body; and
the street lamp assembly is fixed on the rod cover.

Compared with the prior art, the street lamp of the present application achieves an installation and disassembly of two adjacent rod bodies by rotating the upper buckle or the lower buckle, which is easy and convenient, thus improving an efficiency of the installation of the splicing rod of outdoor equipment. Also, dividing the rod into a plurality of rod bodies may reduce requirements of transportation and installation of equipment, thus reducing costs of transportation and installation.

Furthermore, the street lamp assembly includes a power supply unit provided inside the rod bodies and a lighting unit provided outside of the rod bodies; the power supply unit includes a supporting frame, a converter, a storage battery and a solar energy panel; the supporting frame is fixed on an inner wall of the rod bodies, the converter and the storage battery is installed on the supporting frame, the solar energy panel is laid on at least a part of the outside of the rod bodies; the solar energy panel, the converter, the storage battery and the lighting unit are electrically connected sequentially, powered by solar energy and are environmentally friendly and energy-saving.

Furthermore, the lighting unit includes a connecting elbow, a movable arm and a solar powered lamp; one end of the connecting elbow extends along a direction parallel to the axis of the rod bodies, another end of the connecting elbow is bent and hinged with the movable arm; the solar powered light is fixed on one side of the movable arm away from the connecting elbow and is rotated with the movable arm to adjust the angle of illumination of the street lamp.

For better understanding and implementing, a detailed description of the present application is given with accompanying drawings.

### BRIEF DESCRIPTION

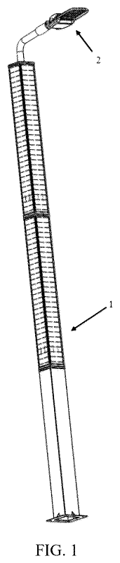

FIG. 1 is a schematic structural diagram of a street lamp of an embodiment of the present application;

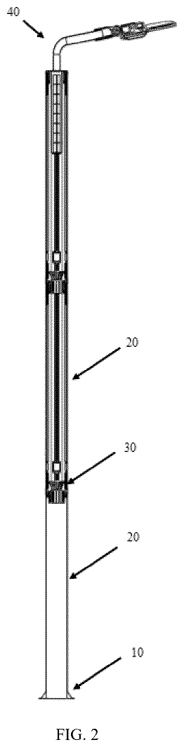

FIG. 2 is a schematic cross-sectional structural diagram of a street lamp in FIG. 1;

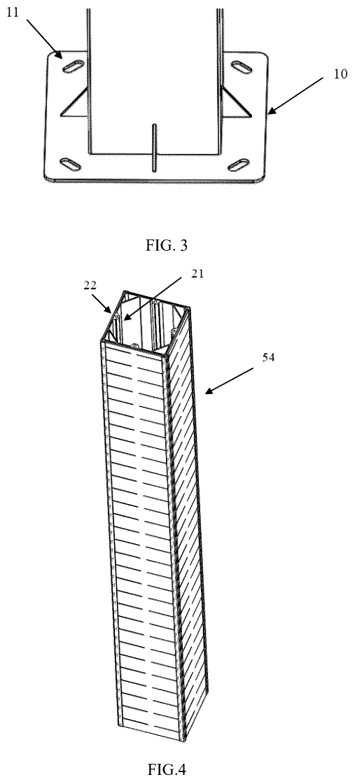

FIG. 3 is a schematic structural diagram of a base of an embodiment of the present application;

FIG. 4 is a schematic structural diagram of a rod body of an embodiment of the present application;

FIG. 5 is a top view of the rod body in FIG. 4;

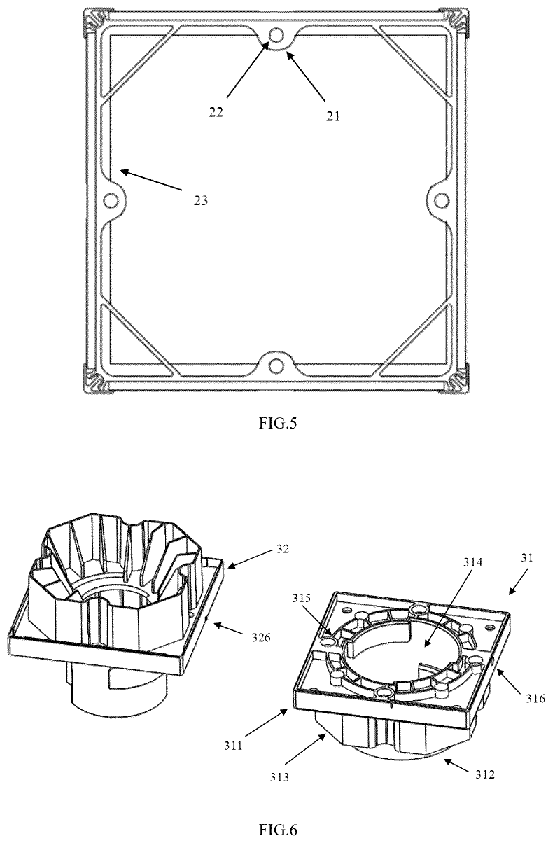

FIG. 6 is an exploded view of a rotating buckle of an embodiment of the present application;

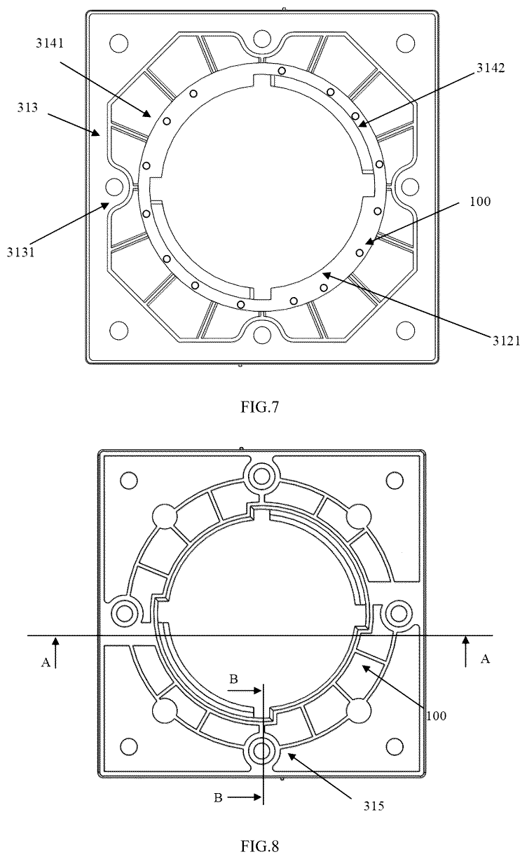

FIG. 7 is a bottom view of a lower buckle of an embodiment of the present application;

FIG. 8 is a top view of a lower buckle of an embodiment of the present application;

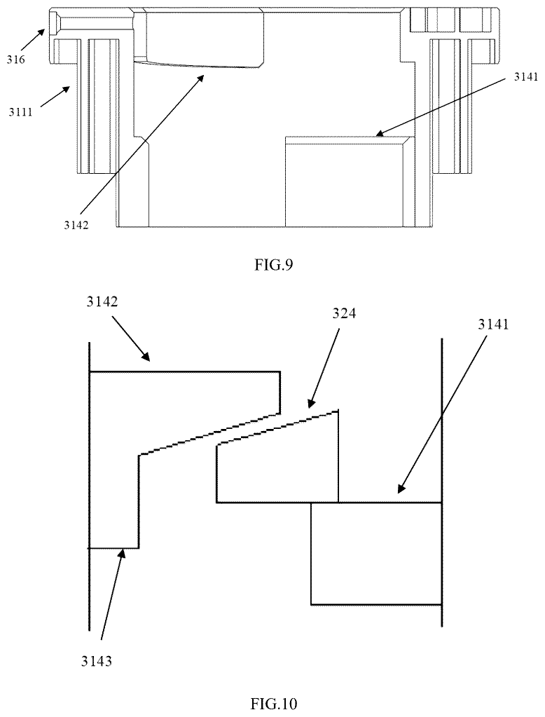

FIG. 9 is a cross-sectional projection diagram along the line A-A in FIG. 8;

FIG. 10 is a schematic cross-sectional diagram of the lower buckle and an upper buckle of another embodiment of the present application;

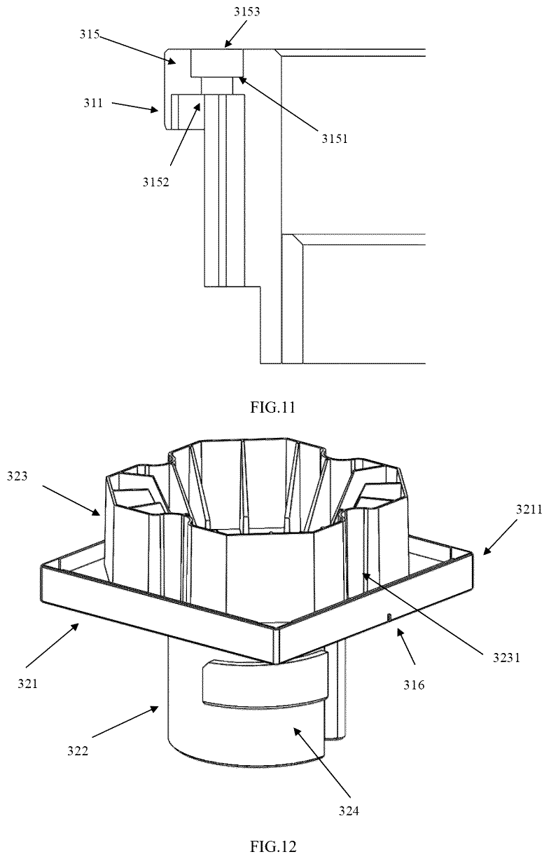

FIG. 11 is a cross-sectional projection diagram along the line B-B in FIG. 8;

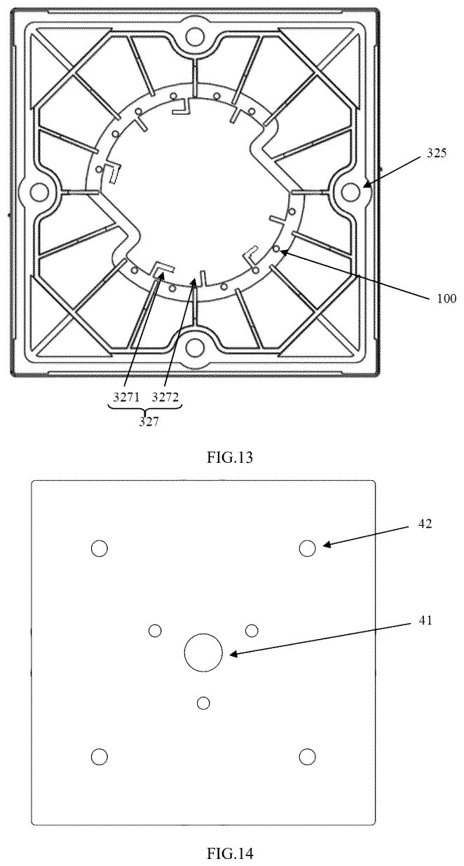

FIG. 12 is a schematic structural diagram of the upper buckle of an embodiment of the present application;

FIG. 13 is a top view of the upper buckle in FIG. 12;

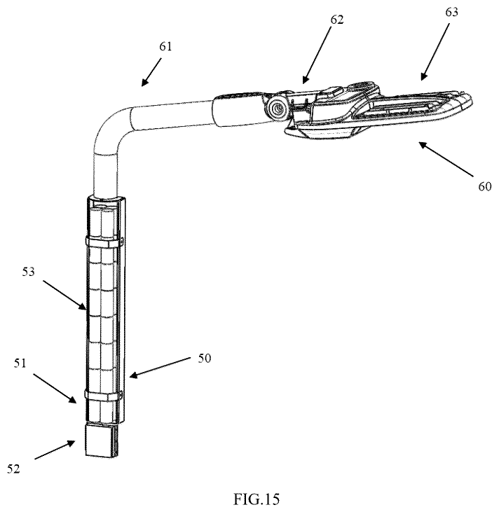

FIG. 14 is a top view of a rod cover of an embodiment of the present application;

FIG. 15 is a schematic structural diagram of a street lamp assembly of an embodiment of the present application.

### DETAILED DESCRIPTION

In the description of the present application, it should be understood that, the directions or positional relationships indicated by the terms “center”, “longitudinal”, “transverse”, “upper”, “down”, “front”, “rear”, “left”, “right”, “vertical”, “horizontal”, “top”, “bottom”, “inner”, and “external” etc. are based on the directions or positional relationships shown in drawings. These relative terms are only for convenience of description and do not indicate or imply that device or element referred to must have a specific orientation, be constructed and operate in a specific orientation, and therefore cannot be understood as a limitation of the present invention. In the description of the present application, the phrase “a plurality of” means two or more unless otherwise indicated.

Please refer to FIG. 1 to FIG. 3. Take an outdoor equipment-street lamp as an example. In this embodiment, a street lamp of the present application includes a splicing rod of outdoor equipment 1 and a street lamp assembly 2. The splicing rod of outdoor equipment 1 is provided on a mounting surface such as ground, etc. vertically, and an extension direction of the splicing rod of outdoor equipment 1 is perpendicular to the mounting surface. The street lamp assembly 2 is provided above the splicing rod of outdoor equipment 1, and supported by the splicing rod of outdoor equipment 1. In addition, the outdoor equipment may be an equipment such as an outdoor traffic signal, a signboard, and a billboard, etc.

Wherein, the splicing rod of outdoor equipment 1 includes a base 10, rod bodies 20, a rotating buckle 30 and a rod cover 40. One side of the base 10 is planar so as to be in contact with the ground. The number of rod bodies 20 is two or more, one rod body 20 is fixedly connected above the base 10 and extends along a vertical direction. Each rod body 20 is arranged up and down along its axial direction. The rotating buckle 30 is connected between two adjacent rod bodies 20. The rod cover 30 covers a top of rod body 20 at the uppermost end. The street lamp assembly 2 is fixedly connected to the rod cover 40. Each rod body 20 is internally communicated with each rotating buckle 30 to form a wiring space inside. Cables such as power wires, signal wires etc. pass through the wiring space from the base 10, and are connected to the rod cover 40 and are electrically connected to the street lamp assembly 2.

In this embodiment, four corners of the base 10 are provided with fixing holes 11. When users install the splicing rod of outdoor equipment 1 at a specified position, bolts are used to pass through the fixing holes 11 to fix the base 10 on the mounting surface such as ground, etc.

Please refer to FIG. 4. and FIG. 5. The rod body 20 is hollow inside. At least one end of the extension direction of the rod body 20 is at least provided with a positioning block 21 and a mounting hole 22 for installing the rotating buckle 30. The positioning block 21 is protrudingly provided on an inner sidewall of the rod body 20 and is at least disposed on one end of the extension direction of the rod body 20. It should be understood that, when both ends of the rod body 20 are mounted with the rotating buckle 30, the positioning block 21 is protrudingly provided on the both ends of an inner sidewall of the rod body 20 correspondingly. The mounting hole 22 is provided on the positioning block 21. An axial direction of the mounting hole 22 is parallel to the extension direction of the rod body 20. In this embodiment, the rod body 20 is an aluminum alloy part, a thickness of a wall of the rod body 20 is 3.5 mm, which ensures a strength. Furthermore, at least one rod body 20 is also provided with steel wire mesh 23. The steel wire mesh 23 is laid on an inner circumferential surface of the rod body 20, and extends along the extension direction of the rod body 20. Compared with increasing the thickness of the rod body 20, a grid-like structure of the steel wire mesh 23 increases the strength without increasing a weight of the rod body 20 excessively, and thus saving materials.

Please refer to FIG. 6. The rotating buckle 30 includes a lower buckle 31 and an upper buckle 32. The lower buckle 31 is fixedly installed on a top of the rod body 20 located below, and the upper buckle 32 is fixedly installed on a bottom of the rod body 20 located above. The lower buckle 31 and the upper buckle 32 may be rotated relative to each other to either to engage with or disengage from each other.

Please refer to FIG. 6 to FIG. 10. The lower buckle 31 is provided with a lower base 311, a lower connecting cylinder 312, a lower connecting block 313, a clamping slot 314 and a stepped hole 315. A lower flange 3111 is provided on one side of the lower base 311 away from the upper buckle 32. The lower flange 3111 extends along an outer periphery of the lower base 311. The lower connecting cylinder 312 is protrudingly provided on one side of the lower base 311 away from the upper buckle 32. An axis of the lower connecting cylinder 312 is parallel to the extension direction of the rod body 20. A lower opening 3121 is provided on a middle of the lower connecting cylinder 312. The upper buckle 32 is inserted into the lower buckle 31 through the lower opening 3121. The lower connecting block 313 surrounds an outside of the lower connecting cylinder 312 and has a certain gap with respect to the lower flange 3111. A lower concave portion 3131 concave to an interior of the lower connecting cylinder 312 is provided on an outside sidewall of the lower connecting block 313. The lower concave portion 3131 passes through the lower connecting block 313 along the extension direction of the rod body 20. When projects along the axial direction of the rod body 20, a shape of a cross-section of the lower concave portion 3131 is basically as same as a shape of a cross-section of the positioning block 21. The positioning block 21 of the rod body 20 located below is inserted into and engaged with the lower concave portion 3131, and located between the lower flange 3111 and the lower concave portion 3131, achieving a positioning of the rod body 20 on the lower buckle 31. The clamping slot 314 is provided on an inner sidewall of the lower connecting cylinder 312. At least one part of the upper buckle 32 may be inserted into the clamping slot 314 and engaged with the lower buckle 31, or, at least one part of the upper buckle 32 is disengaged from the clamping slot 314 to achieve a separation of the lower buckle 31 and the upper buckle 32. In this embodiment, the clamping slot 314 includes a first clamping block 3141 and a second clamping block 3142. The first clamping block 3141 and the second clamping block 3142 are protrudingly provided the inner sidewall of the lower connecting cylinder 312, and are separated from each other with a distance along an axial direction of the lower connecting cylinder 312. Along the axis of the lower connecting cylinder 312, the first clamping block 3141 is located at one side near to the rod body 20 located below, and the second clamping block 3142 is located at one side near to the upper buckle 32. When projects along the axis of the rod body 20, at least one part of the first clamping block 3141 and the second clamping block 3142 do not overlap. Furthermore, an axis of the lower connecting cylinder 312 is perpendicular to a sidewall of the first clamping block 3141 facing the upper buckle 32, thus abuts on the upper buckle 32. In this embodiment, along the axis of the rod body 20, side surfaces of the first clamping block 3141 and the second clamping block 3142 opposite toward each other are parallel to each other. In another embodiment, with reference to FIG. 10, along the axis of the rod body 20, side surfaces of the first clamping block 3141 and the second clamping block 3142 opposite toward each other are not parallel to each other, and in the second clamping block 3142, a distance between one side near to the first clamping block 3141 and the first clamping block 3141 is larger than a distance between one side away from the first clamping block 3141 and the first clamping block 3141. Furthermore, a third clamping block 3143 is provided. The third clamping block 3143 is connected to one side of the second clamping block 3142 away from the first clamping block 3141, and extends along a direction away from the upper buckle 32 to limit a position of a rotation of the upper buckle 32. The stepped hole 315 passes through the lower base 311 along a direction parallel to the axial direction of the rod body 20. An area of a cross-section of one side of the stepped hole 315 away from the upper buckle 32 is smaller than an area of a cross-section of one side of the stepped hole 315 near the upper buckle 32, thus a supporting surface 3151, a first connecting hole 3152 and a second connecting holes 3153 with different diameters are formed. The first connecting hole 3152 is located at one side away from the upper buckle 32, the second connecting hole 3153 is located at one side near to the upper buckle 32, and the supporting surface 3151 is located between the first connecting 3152 and the second connecting hole 3153. The diameter of the first connecting hole 3152 is smaller than the diameter of the second connecting hole 3153. The first connecting hole 3152 is configured to accommodate a bolt connecting the rod body 20 located below to the lower buckle 31, the bolt connecting the rod body 20 located below to the lower buckle 31 is supported by the supporting surface 3151. The second connecting hole 3153 is configured to accommodate a bolt connecting the lower buckle 31 to the upper buckle 32.

Please refer to FIG. 12 and FIG. 13. The upper buckle 32 is provided with an upper base 321, an upper connecting cylinder 322, an upper connecting block 323, a clamping block 324 and a mounting hole 325. One side surface of the upper base 321 is in contact with the lower base 311 to be supported. An upper flange 3211 is provided on one side of the upper base 321 facing away from the lower base 311, and the upper flange 3211 extends along an outer periphery of the upper base 321. The upper connecting cylinder 322 is protrudingly provided on one side of the upper base 321 facing the lower base 311 and is communicated with the upper base 321. An axis of the upper connecting cylinder 322 is parallel to the axis of the lower connecting cylinder 312. An outer diameter of the upper connecting cylinder 322 is smaller than an outer diameter of the lower connecting cylinder 312. In this embodiment, the axis of the upper connecting cylinder 322 and the axis of the lower connecting cylinder 312 is overlapped with each other. The upper connecting block 323 surrounds an outside of the upper connecting cylinder 322, and has a certain gap between the upper flange 3211. An upper concave portion 3231 concave to an interior of the upper connecting cylinder 322 is provided on an outer sidewall of the upper connecting block 323. The upper concave portion 3231 passes through the upper connecting block 323 along a direction parallel to the axial direction of the rod body 20. When projects along the axis of the rod body 20, a shape of a cross-section of the upper concave portion 3231 is basically as same as a shape of a cross-section of the positioning block 21. The positioning block 21 of the rod body 20 located above is inserted into and engaged with the upper concave portion 3231, and is located between the upper flange 3211 and the upper concave portion 3231, achieving a positioning of the rod body 20 located above on the upper buckle 32. The clamping block 324 is provided on an outer peripheral surface of the upper connecting cylinder 322, and engaged with the clamping slot 314, thus limiting the upper buckle 32 from being disengaged from the lower buckle 31. When the upper connecting cylinder 322 of the upper buckle 32 is inserted into the lower connecting cylinder 312, first the clamping block 324 abuts on the first clamping block 3141, then the upper buckle 32 is rotated to make the clamping block 324 slide to a position below the second clamping block 3142 along the first clamping block 3141, until the clamping block 324 abuts on the third clamping block 3143. The mounting hole 325 is provided on the upper base 321 and communicated with the stepped hole 315. The upper buckle 32 is fixed to the lower buckle 31 by screwing a bolt into the mounting hole 325.

Furthermore, a first mark 316 and a second mark 326 are provided on outer sidewalls of the lower base 311 and the upper base 321 respectively. The second mark 326 is aligned with the first mark 316 after the upper buckle 32 is rotated at a certain angle, so that it may be observed from an outside whether the lower buckle 31 and the upper buckle 32 are installed properly. In this embodiment, the first mark 316 is an observing hole provided on the lower base 311 along a radial direction of the lower connecting cylinder 312, which is configured to observe a connection condition between an interior of the lower buckle 31 and the upper buckle 32. The second mark 326 is a projection provided on an outer sidewall of the upper base 321.

Furthermore, a plurality of rebars extending to a direction parallel to the axis of the rod body 20 are provided inside the lower connecting cylinder 312 and/or the upper connecting cylinder 322. The plurality of rebars 100 are arranged along a circumferential direction of the rod body 20 and embedded into the rod body 20, thus enhancing the strength.

Furthermore, a plurality of cable fasteners 327 are provided on an inner sidewall of the upper connecting cylinder 322. Each cable fastener of the plurality of cable fasteners 327 includes a first cable fastener 3271 extending along a direction parallel to the axial direction of the rod body 20. When projects along the axis of the rod body 20, one end of the first cable fastener 3271 is contacted to the inner sidewall of the upper connecting cylinder 322 and extends along a radial direction of the upper connecting cylinder 322, and a sidewall of another end of the first cable fastener 3271 is provided opposite to the inner sidewall of the upper connecting cylinder 322. Cables are stuck between the first cable fastener 3271 and the inner sidewall of the upper connecting cylinder 322. Furthermore, each cable fastener of the plurality of cable fastener 327 further includes a second cable fastener 3272 extending along a direction parallel to the axial direction of the rod body 20. When projects along the axis of the rod body 20, the second cable fastener 3272 extends along the radial direction of the upper connecting cylinder 322, and is near to one side of the first cable fastener 3271 away from the inner sidewall of the upper connecting cylinder 322 and separated with it with a certain distance, forming a cable accommodating space between the first cable fastener 3271 and the second cable fastener 3272.

Furthermore, the number of the clamping slot 314 of the lower buckle 31 and the clamping block 324 of the upper buckle 324 is two, two clamping slots 314 and two clamping blocks 324 are arranged opposite to each other along the circumferential direction of the plurality of rod bodies 20. One clamping slot 314 is engaged with one clamping block 324.

Please refer to FIG. 14. The rod cover 40 is provided with a slot 41 for inserting the street lamp assembly 2 and connecting holes 42 communicated with the mounting holes 22. In this embodiment, when projects along the axis of the rod body 20, the slot 41 is near to a center of the rod cover 40, and the connecting holes 42 are provided at four corners of the rod cover 40. Cables connected internally between the rod body 20 and the rotating buckle 30 are connected to an outside through the slot 41, and bolts are inserted into uppermost mounting holes 22 of the plurality of mounting holes 22 and the plurality of connecting holes 42, thus the rod cover 40 is installed on a top of an uppermost rod body 20.

Please refer to FIG. 15. The street lamp assembly 2 includes a power supply unit 50 and a lighting unit 60. The power supply unit 50 is disposed inside the rod body 20 and supplies power to the lighting unit 60 disposed outside the plurality of rod bodies 20. In this embodiment, the power supply unit 50 includes a supporting frame 51, a converter 52, a storage battery 53 and a solar energy panel 54. The supporting frame 51 is fixed on an inner wall of the rod body 20 by means such as bolts, welding and is near to the lighting unit 60. The converter 52 is provided below the supporting frame 51. The storage battery 53 is fixed on the supporting frame 51 and electrically connected to the converter 52 and the lighting unit 60 respectively. The solar energy panel 54 is laid on at least one part of an outer sidewall of the rod body 20. Cables of the solar energy panel 54 extend into the wiring space, and the solar energy panel 54 is electrically connected to the converter 52. The converter 52 converts the solar energy to electricity, and the electricity is stored in the storage battery 53 to power the lighting unit 60. In this embodiment, the lighting unit 60 includes a connecting elbow 61, a movable arm 62 and a solar powered lamp 63. One end of the connecting elbow 61 extends along a direction parallel to the axis of the rod body 20, then is bent 90 degrees and hinged with the movable arm 62. The movable arm 62 may be rotated around an axis parallel to the ground. The solar powered lamp 63 is fixed on one side of the movable arm 62 away from the connecting elbow 61, and is rotated with the movable arm 62 to adjust an angle of lighting.

In addition, in this embodiment, a shape of a cross-section of an outer periphery of the rod body 20 is set as a square. However, the shape of the cross-section of the rod body 20 may also be set as round, rectangular, polygonal, profiled, etc. as needed.

Compared with the prior art, the splicing rod of outdoor equipment and street lamp of the present application has following advantages:
1. Two adjacent rod bodies are engaged with each other by the rotating buckle, which makes disassembly and assembly easy and convenient for transportation, and also enhances stability;
2. The upper buckle and the lower buckle may be not only engaged with buckles, but also may be fixedly connected to each other through bolts, so that it is a stable structure and not easy to loosen;
3. Powered by solar energy, which saves the energy and is more environmentally friendly;
4. A range of lighting may be adjusted, which is wide applicability.

The embodiments mentioned above merely express several embodiments of the present application, and the description thereof is specific and detailed, but cannot be thus construed as limiting the scope of the present application. It should be indicated that a person ordinarily skilled in the art still can make alterations and improvements, without departing from the concept of the present application, all of which fall into the scope of protection of the present application.

What is claimed:

1. A splicing rod of outdoor equipment, comprising:
a base provided at a bottom of the splicing rod of outdoor equipment to support;
two or more rod bodies, wherein, each rod body of the rod bodies is arranged up and down along an axis, and the base is fixedly provided on a bottom of a lowest rod body;
a rotating buckle, wherein, the rotating buckle is located between two adjacent rod bodies, and includes an upper buckle fixedly connected to an upper rod body and a lower buckle fixedly connected to a lower rod body, and the upper buckle and the lower buckle is able to rotate relative to each other around the axis of the rod bodies;
a rod cover configured to install outdoor equipment, wherein, the rod cover is provided on a top of an uppermost rod body.

2. The splicing rod of outdoor equipment of claim 1, wherein, one of the lower buckle and the upper buckle is provided with a clamping slot, the other of the lower buckle and the upper buckle is provided with a clamping block, the clamping block is engaged into or disengaged from the clamping slot as the lower buckle rotates relative to the upper buckle.

3. The splicing rod of outdoor equipment of claim 2, wherein, the clamping slot is provided on the lower buckle; the lower buckle is further provided with a lower base, a lower connecting cylinder, a lower connecting block and a stepped hole; the upper buckle is installed on the lower base, a lower flange extending along a periphery of the lower base is protrudingly provided on one side of the lower base away from the upper buckle; the lower connecting cylinder is protrudingly provided on one side of the lower base away from the upper buckle, the upper buckle is inserted into the lower connecting cylinder, and an axis of the upper buckle is parallel to the axis of the rod bodies, the clamping slot is provided on an inner sidewall of the lower connecting cylinder; the lower connecting block surrounds an outside of the lower connecting cylinder and has a gap between the lower flange, the rod body is disposed between the lower flange and the lower connecting block; the stepped hole passes through the lower base, an axis of the stepped hole is parallel to the axis of rod bodies, and a diameter of one side of the stepped hole near to the upper buckle is larger than a diameter of one side of the stepped hole away from the upper buckle.

4. The splicing rod of outdoor equipment of claim 3, wherein, the rod bodies are hollow inside, at least one end of each rod body of the rod bodies is provided with a positioning block and a mounting hole, the positioning block is protrudingly provided at an inner wall of the rod body, the mounting hole is provided on the positioning block and is communicated with the stepped hole; a lower concave portion concave to an interior of the lower connecting cylinder is provided on an outside sidewall of the lower connecting block; the positioning block is inserted into the lower concave portion.

5. The splicing rod of outdoor equipment of claim 3, wherein, the clamping slot includes a first clamping block and a second clamping block, the first clamping block and the second clamping block are protrudingly provided on the inner sidewall of the lower connecting cylinder and separated from each other with a certain distance; when projects along the axis of the rod bodies, at least one part of the first clamping block and the second clamping block do not overlap.

6. The splicing rod of outdoor equipment of claim 4, wherein, the upper buckle is provided with an upper base, an upper connecting cylinder, an upper connecting block, a clamping block and a mounting hole; one side surface of the upper base is in contact with the lower base, and an upper flange extending along an outer periphery of the upper base is protrudingly provided on one sidewall of the upper base facing away from the lower base; the upper connecting cylinder is protrudingly provided on one side of the upper base facing the lower base, and an axis of the upper connecting cylinder is parallel to the lower connecting cylinder; the upper connecting block surrounds an outside of the upper connecting cylinder, and has a gap with respect to the upper flange; the clamping block is protrudingly provided on an outer sidewall of the upper connecting cylinder; the mounting hole is provided on the upper base and communicated with the stepped hole.

7. The splicing rod of outdoor equipment of claim 6, wherein, an upper concave portion concave to an interior of the upper connecting cylinder is provided on an outer sidewall of the upper connecting block, the positioning block is inserted into the upper concave portion.

8. A street lamp, comprising: the splicing rod of outdoor equipment of claim 1 and a street lamp assembly; the street lamp assembly is fixed on the rod cover.

9. The street lamp of claim 8, wherein, the street lamp assembly includes a power supply unit provided inside the rod bodies and a lighting unit provided outside of the rod bodies; the power supply unit includes a supporting frame, a converter, a storage battery and a solar energy panel; the supporting frame is fixed on an inner wall of the rod bodies, the converter and the storage battery is installed on the supporting frame, the solar energy panel is laid on at least a part of the outside of the rod bodies; the solar energy panel, the converter, the storage battery and the lighting unit are electrically connected sequentially.

10. The street lamp of claim 8, wherein, the lighting unit includes a connecting elbow, a movable arm and a solar powered lamp; one end of the connecting elbow extends along a direction parallel to the axis of the rod bodies, another end of the connecting elbow is bent and hinged with the movable arm; the solar powered light is fixed on one side of the movable arm away from the connecting elbow and is rotated with the movable arm.
